(19) United States
(12) Patent Application Publication
(10) Pub. No.: US 2018/0285595 A1
(43) Pub. Date: Oct. 4, 2018

(54) VIRTUAL AGENT FOR THE RETRIEVAL AND ANALYSIS OF INFORMATION

(71) Applicant: IP Street Holdings LLC, Spokane, WA (US)

(72) Inventor: Carl Reed Jessen, Spokane, WA (US)

(21) Appl. No.: 15/945,621

(22) Filed: Apr. 4, 2018

Related U.S. Application Data
(60) Provisional application No. 62/481,502, filed on Apr. 4, 2017.

(51) Int. Cl. G06F 21/62; G06F 17/30; G06F 21/60; H04L 29/08

(52) U.S. Cl. CPC G06F 21/6245; H04L 67/14; G06F 21/604; G06F 17/30867

(57) ABSTRACT

Techniques for utilizing a virtual agent for the retrieval and analysis of information are described. A virtual agent device initiates an interactive communication session with a user. As part of the interactive communication session, the virtual agent device receives a query from the user. The virtual agent device generates a response to the query based on a fact set from which the computing device obtains data for the response, a global rule set, and a local rule set. The virtual agent device applies the global rule set and the local rule set to the data to refine the response according to a context of the interactive communication session. The virtual agent device outputs the response that includes the refinements made according to the global and local rule sets, such as a natural language output via a speaker of the virtual agent device.

### CROSS-REFERENCE TO RELATED APPLICATIONS

This application claims priority and benefit under 35 USC 119(e) to U.S. application Ser. No. 62/481,502, filed on Apr. 4, 2017, the contents of which are incorporated herein by reference in their entirety.

### BACKGROUND

Advances in computer technology, particularly natural language processing and artificial intelligence, have led to “virtual agent” devices that can carry out intelligent conversations with users including responding to a user's questions and performing non-verbal behaviors in response to the user's input. Conventional virtual agent devices and systems can execute generic commands, such as to play a song or recite current weather conditions. However, these conventional virtual agent devices and systems lack functionality for interfacing with local applications, drawing information from multiple applications, and building a context to deliver specific information that is relevant to an interactive session with a user. Consequently, users are left with an incomplete number of sources to draw information using a virtual agent device, and the virtual agent device may deliver irrelevant or incomplete information to the user as a response.

### BRIEF SUMMARY

Techniques for utilizing a virtual agent for the retrieval and analysis of information are described. In one example, a computing device, such as a virtual agent, initiates an interactive communication session with a user. As part of the interactive communication session, the computing device receives a query from the user. The computing device generates a response to the query based on a fact set from which the computing device obtains data for the response, a global rule set, and a local rule set. The computing device applies the global rule set to the data to refine the response according to a context of the interactive communication session. The global rule set is a publicly accessible rule set, such as federal or state laws, codes of conduct, industry practices, and so forth. Then, the computing device applies the local rule set to the data to refine the response according to the context of the interactive communication session. The local rule set is a rule set that is specific to the fact set, such as a privacy standard for a client or patient associated with the data, conflict of interest concerns associated with the data, account permissions associated with the data, and so on. The computing device outputs the response that includes the refinements made according to the global and local rule sets, such as a natural language output via a speaker of the computing device, in a user interface, and so forth.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an illustration of an environment in an example implementation that is operable to employ a virtual agent for the retrieval and analysis of information according to the techniques described herein.

FIG. 2 depicts a system in an example implementation showing operation of a response generation module of FIG. 1 in greater detail.

FIG. 3 illustrates a response generation module 102 in accordance with one embodiment.

FIG. 4 depicts an example interactive communication session using a virtual agent for the retrieval and analysis of information in accordance with one or more implementations.

FIG. 5 depicts an example context-specific application that may be employed in a system utilizing a virtual agent for the retrieval and analysis of information in accordance with one or more implementations.

FIG. 6 is a flow diagram depicting a procedure in an example implementation in which a response to a query is generated by applying a global rule set and a local rule set to data for the response in accordance with one or more implementations.

FIG. 7 illustrates an example system including various components of an example device that can be implemented as any type of computing device as described and/or utilized with reference to FIG. 1 through FIG. 6 to implement embodiments of the techniques described herein.

### DETAILED DESCRIPTION

Conventional virtual agent systems and devices lack functionality for interfacing with local applications, drawing information from multiple applications, and building a context to deliver specific information that is relevant to an interactive session with a user. Much like having a discussion between two humans, users desire virtual agents that can understand a context of a discussion, including interpreting terms that may have vague or multiple meanings outside of a particular context, answering questions with information that is relevant to a discussion, presenting information based on who is part of a discussion, and so forth.

For example, a discussion between a doctor and a nurse regarding a patient's diagnosis within the private confines of the doctor's office would include different information than a discussion between the doctor and the nurse on the subway, in order to ensure privacy for the patient in accordance with federal and state laws. Should a virtual agent be present for either of these conversations, the techniques described herein allow the virtual agent to understand the context of the two different conversations and interact with the participants of the conversations accordingly.

Using knowledge of the context of a conversation or interaction, the virtual agent can further draw information from appropriate sources, such as local applications and datasets, that conventional virtual agent systems could previously not successfully access.

In a first example, a user may initiate an interactive communication session between the user and a computing device, such as a virtual agent device. An interactive communication session may be initiated by voice activation of a computing device via a “wake word”, making a hand or body gesture, directing the direction of one's gaze, by opening a chat box in a user interface of a computing device, by calling a customer service telephone number, and so on. According to these examples, the virtual agent in these cases may be a computing device having a hands-free speaker that is controlled by voice commands; a desktop, laptop, or mobile computing device; or a mobile or landline telephone, to name a few examples.

After the interactive communication session has begun, the computing device receives a query from the user as part of the interactive communication session. In examples, the computing device receives an utterance from the user, where the utterance is a chain of spoken or written language, and translates the utterance into a query of computer-readable instructions. Alternatively or additionally, the user may provide the query without an utterance, such as by entering computer code for the query. The utterance may be received via voice command, typing input, selection of a menu item in a user interface, selection of a menu item in an automated attendant telephony system, and so forth, and translated into a query of computer-readable instructions on behalf of the user.

The computing device then generates a response to the query based on a fact set from which the computing device obtains data for the response, and applying a global rule set and a local rule set to the data in order to refine the response. The global rule set is a publicly accessible rule set, such as federal or state laws, codes of conduct, industry practices, and so forth. The local rule set is specific to the fact set, such as privacy concerns related to a client or patient associated with the data, conflict of interest concerns associated with the data, account permissions associated with the data, and so on. The generated response, including the refinements made according to the global and local rule set, is output using a natural language output via a speaker of the computing device, in a user interface, as part of an email, an action taken by the computing device, and so forth.

To illustrate, the computing device may receive an utterance from an attorney user referencing a section of the attorney's notes on a client's pending lawsuit. The computing device may translate the utterance into a computer-readable query, and access the section of the attorney's notes as data for the response. Before outputting the notes, however, the computing device may analyze the environment that the attorney is currently in, and compare the environment to global and local rules. For example, the attorney may be in a negotiation meeting with opposing counsel when the attorney makes the utterance. In this scenario, the computing device may utilize information on the current environment in generating a response, along with publicly available rules for discovery in a lawsuit, and components of the attorney's notes in the note-taking application where the section of notes was created.

The note-taking application may contain flags such as “received in discovery,” “attorney work product,” and/or “attorney-client privilege,” on specific pieces of information that the computing device can use in determining how to refine a response for output.

In the scenario of the negotiation meeting with opposing counsel, the computing device can generate a response that narrowly answers the question to avoid unintended information to be accessed by the opposing counsel. Further, the computing device may opt to output the answer to the query with a narrowly-phrased natural language output through a speaker, rather than displaying the information on a screen where the context in the display may be used adversely. On the other hand, if the attorney asks for the same section of notes in the privacy of her office, the computing device may utilize this information and display the entire section of notes on the attorney's desktop monitor, knowing that information will not be compromised in this environment. Using a global rule set and a local rule set applied to data to generate a context-specific response gives users the correct information more accurately, while preventing unintended distributions of information to unauthorized users.

In the following discussion, an example environment is described that may employ the techniques described herein. Example procedures are also described which may be performed in the example environment as well as other environments. Consequently, performance of the example procedures is not limited to the example environment and the example environment is not limited to performance of the example procedures.

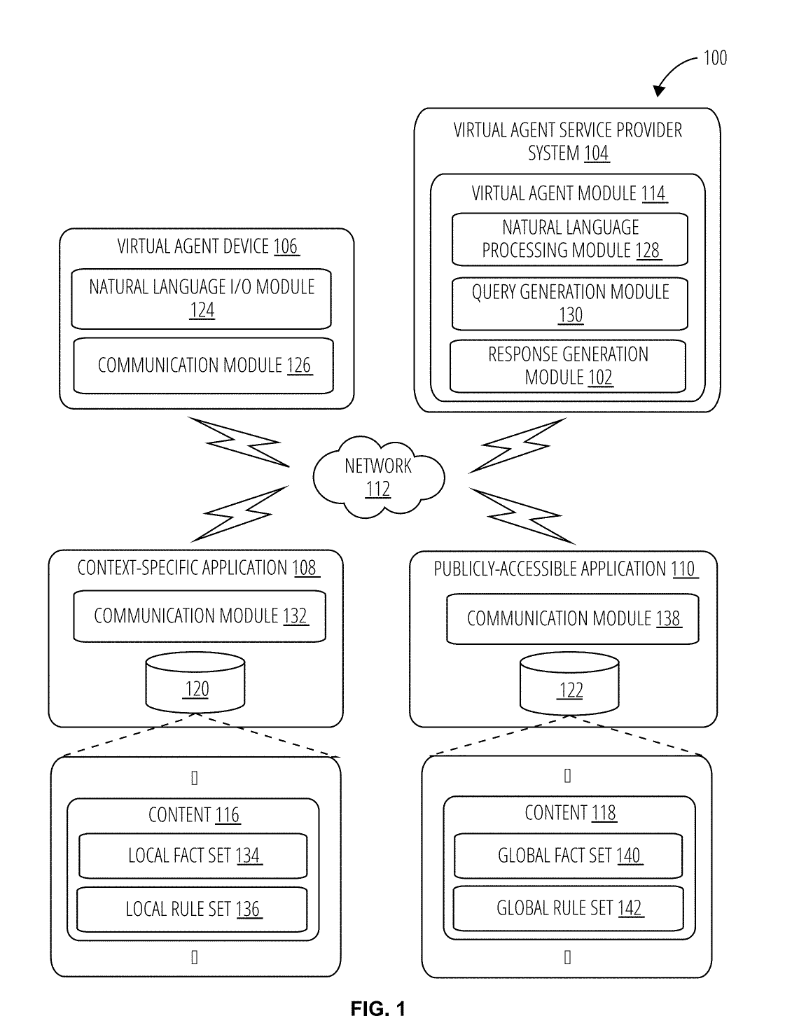

FIG. 1 is an illustration of a digital medium environment 100 in an example implementation that is operable to employ techniques for the retrieval and analysis of information using a virtual agent as described herein. The illustrated environment includes a virtual agent service provider system 104, a virtual agent device 106, a context-specific application 108, and a publicly-accessible application 110 that are communicatively coupled, one to another, via a network 112. Computing devices that implement the virtual agent service provider system 104, the virtual agent device 106, the context-specific application 108, and the publicly-accessible application 110 may be configured in a variety of ways.

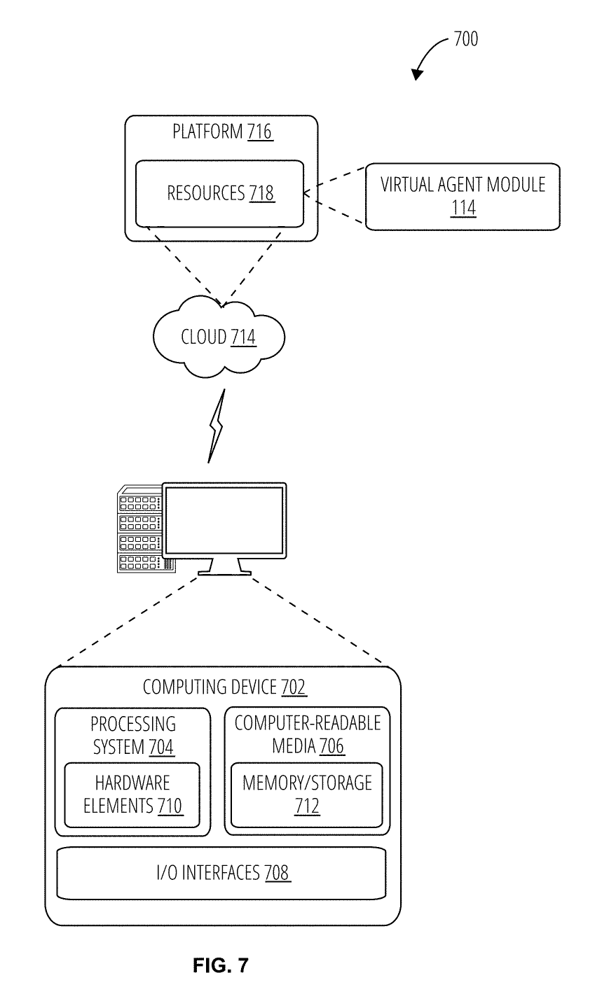

A computing device, for instance, may be configured as a desktop computer, a laptop computer, a mobile device (e.g., assuming a handheld configuration such as a tablet or mobile phone), a motion-capable robot, and so forth. Thus, a computing device may range from full resource devices with substantial memory and processor resources (e.g., personal computers, game consoles) to a low-resource device with limited memory and/or processing resources (e.g., mobile devices). Additionally, although a single computing device is shown in some examples, the computing device may be representative of a plurality of different devices, such as multiple servers utilized by a business to perform operations “over the cloud” as shown for the virtual agent service provider system 104, and as further described in FIG. 7.

The virtual agent service provider system 104 is illustrated as including a virtual agent module 114 that is implemented at least partially in hardware of a computing device. The virtual agent module 114 is configured to manage online interaction via the network 112 of the virtual agent device 106 with content 116 and content 118, which is stored in storage 120 and storage 122 (respectively) of the context-specific application 108 and the publicly-accessible application 110. The content 116 and content 118 may take a variety of forms, such as an online application, online storage, web service, digital images, digital audio, multimedia, and so forth. Thus, interaction with the content 116 and content 118 by the virtual agent device 106 via the virtual agent service provider system 104 and the network 112 may also take a variety of forms, such as selection of a menu item, voice command, gesture, selection of a hyperlink, and so forth.

The virtual agent device 106 is illustrated as including a natural language input/output module 124 that is implemented at least partially in hardware of a computing device. The natural language input/output module 124 is configured to receive natural language inputs, such as an utterance of spoken or written language, and output information as natural language outputs. Natural language inputs may include voice inputs via a microphone, text inputs via a keyboard, gesture inputs, and so forth. For example, the natural language input/output module 124 may receive a voice command that includes a “wake word” or “wake gesture” indicating the initiation of an interactive communication session.

The natural language input/output module 124 receives a natural language input, and automatically delivers the natural language input to the virtual agent module 114 of the virtual agent service provider system 104, such as by a communication module 126 via the network 112. A natural language processing module 128 of the virtual agent module 114 receives the natural language input, and converts the natural language input to data, such as text, that can be used to generate a computer-readable query by a query generation module 130. The natural language processing module 128 may utilize functionality such as lexical semantics, machine translation, named entity recognition (NER), natural language understanding, optical character recognition (OCR), recognizing textual entailment, relationship extraction, sentiment analysis, topic segmentation and recognition, word sense disambiguation, speech recognition and speech segmentation, conference resolution, discourse analysis, part-of-speech tagging, parsing, sentence breaking, and so forth. While the natural language processing module 128 is pictured at the virtual agent service provider system 104, embodiments are contemplated in which the natural language processing module is additionally or alternatively located at the virtual agent device 106.

The query generation module 130 receives the data from the natural language processing module 128 and generates a computer-readable query based on the data from the natural language input. To generate the query, the query generation module 130 can determine an intent from the data received from the natural language processing module 128 regarding an action the user wants the virtual agent service provider system 104 to execute. For example, the query generation module 130 may generate an SQL query, JPQL query, and so on. The query generation module 130 can further identify, based on the data received from the natural language processing module 128 and a determined intent, one or more applications to send the query for a response. Additionally, the query generation module 130 can determine contextual information to include in the query, such as from an environment where the virtual agent device 106 is located, identities of users in a conversation with the virtual agent device, prior requests from the users of the virtual agent device, and so forth.

The virtual agent module 114 communicates the query to the identified application(s), such as the context-specific application 108 and the publicly-accessible application 110, via the network 112. A communication module 132 of the context-specific application 108 receives the query and uses the query to locate data for a response to the query. The context-specific application 108 can also provide one or more rules from a local rule set 136 as part of the response to the query. Rules supplied from the local rule set 136 may be based on a determined relevance of the rules in the local rule set to the contextual information supplied in the query.

In one example, the context-specific application 108 may be an email application with which a user of the virtual agent device 106 has an email account. The context-specific application 108 may receive a query from the virtual agent service provider system 104 to send an email to a recipient. The context-specific application 108 may access data such as the recipient's email address, email formatting preferences, and so forth from the local fact set 134 of the content 116. However, the email body indicated in the query may include a phrase such as “see attachment for details.” The local rule set 136 may contain a rule that prompts a user when an email contains a phrase containing the word “attachment” but there is not yet an attachment included in the email. Thus, a rule from the local rule set 136 that prompts a user to determine whether the user wants to attach a file before sending an email may be included in the response, along with the data from the local fact set 134.

A communication module 138 of the publicly-accessible application 110 may also receive the query and use the query to locate data for a response to the query. The publicly-accessible application 110 can locate data for a response to the query from a global fact set 140 located in the storage 122. The publicly-accessible application 110 can also provide one or more rules from a global rule set 142 as part of the response to the query. Rules supplied from the global rule set 142 may be based on a determined relevance of the rules in the global rule set to the information supplied in the query. For example, the publicly-accessible application 110 may identify data from the translated utterance or contextual data contained in the query to determine which rules from the global rule set 142 to provide as part of the response to the query.

In an example, the publicly-accessible application 110 may be a website for the United States Internal Revenue Service (IRS). The publicly-accessible application 110 may receive a query from the virtual agent service provider system 104 to determine the earliest that a user will receive their tax refund. The publicly-accessible application 110 may locate data on the typical time frame for receiving a tax refund from the global fact set 140. However, the publicly-accessible application 110 may identify a rule from the global rule set 142 that the IRS cannot issue refunds before a certain date for tax returns that claim the Earned Income Tax Credit or the Additional Child Tax Credit. Because the rule could possibly affect the earliest that the user would receive their tax refund, the rule from the global rule set 142 would be included in the response, along with the data from the global fact set 140. While the above example depicts the publicly-accessible application 110 as a website for the IRS, examples are also contemplated in which the publicly-accessible application 110 is an interface between the virtual agent service provider system 104 and public sources of information. For instance, the publicly-accessible application 110 may translate rules from a public source of information, such as the IRS website, into computer-readable instructions for access by the virtual agent service provider system 104.

The context-specific application 108 then sends a response including data from the local fact set 134 and applicable rules from the local rule set 136 to the virtual agent service provider system 104 using the communication module 132 via the network 112. Similarly, the publicly-accessible application 110 sends a response including data from the global fact set 140 and applicable rules from the global rule set 142 to the virtual agent service provider system 104 using the communication module 138 via the network 112.

A response generation module 102 of the virtual agent service provider system 104 generates a response to the query based on the data from the local fact set 134 and the data from the global fact set 140, as discussed in detail below. The response generation module 102 also refines the response based on the rules from the local rule set 136, the global rule set 142, and the context of the interactive communication session, as discussed above and below.

The response generation module 102 can output the response to the natural language processing module 128, which may translate the response into a natural language output. The natural language processing module 128 may utilize natural language generation, sentiment analysis, topic segmentation and recognition, automatic summarization, and so forth. The natural language output response is communicated to the virtual agent device 106 via the network 112, and output using the natural language input/output module 124, such as by using text-to-speech functionality, displaying content on a display, executing a command, taking a physical action, and so on.

After considering an example system for implementing a virtual agent for the retrieval and analysis of information, consider now a description of the response generation module 102 in further detail.

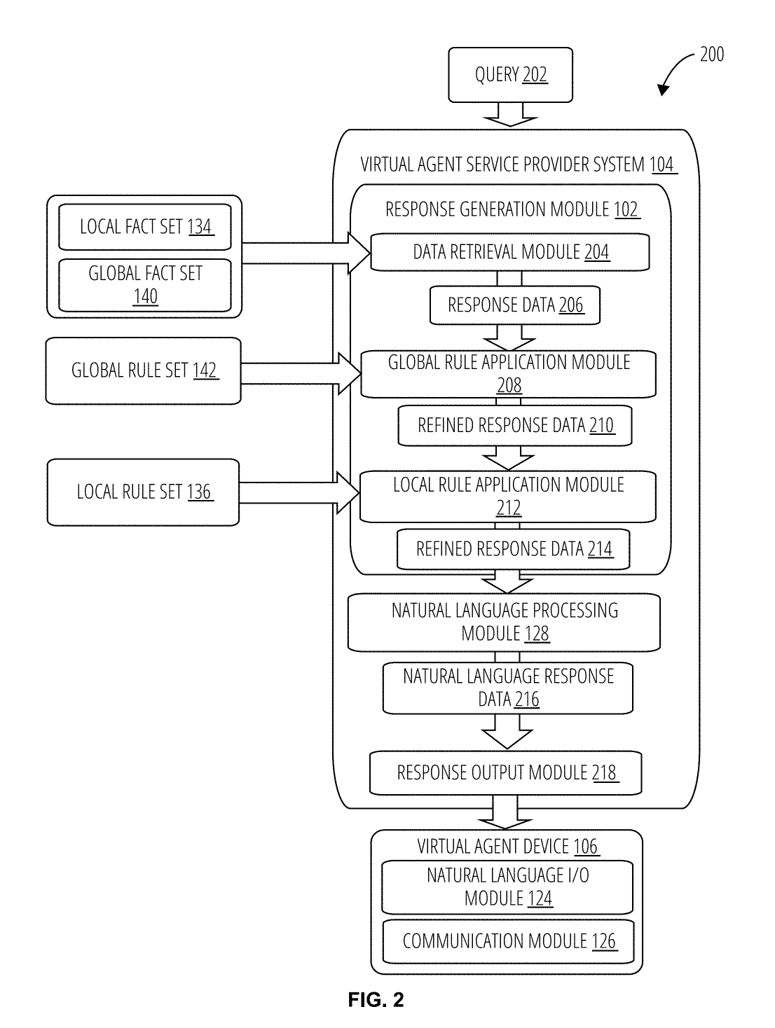

FIG. 2 depicts a system 200 in an example implementation showing operation of the response generation module 102 of FIG. 1 in greater detail. To begin this example, a query 202 is received by a data retrieval module 204 of the response generation module 102. The query 202 may be an SQL query or any other suitable type of query. The query 202 may be received from a query generation module and/or a natural language processing module, such as the query generation module 130 and natural language processing module 128 of FIG. 1. The natural language processing module 128 may translate a natural language input from a user, such as an utterance via voice input or typing input, into text as discussed above. Then, the query generation module 130 may determine an intent of the user's utterance to generate the query. Along with information regarding the natural language input from the user, the query generation module 130 may also include contextual information regarding an interactive communication session between the user and a virtual agent device in the query 202, as discussed above and below.

The data retrieval module 204 utilizes information included in the query 202 to locate data for a response to the query 202 from the local fact set 134 and/or the global fact set 140. The data retrieval module 204 generates response data 206 based on the information regarding the natural language input from the user, such as a command, request, or question. The data retrieval module 204 may also use the contextual information regarding the interactive communication session between the user and the virtual agent device 106 to locate additional and/or potentially relevant information to the natural language input from the user used to generate the query 202.

Next, a global rule application module 208 receives the response data 206, and applies the global rule set 142 to the response data 206. The global rule application module 208 refines the response data 206 to generate refined response data 210, based on one or more rules from the global rule set 142. For instance, the global rule application module 208 can generate refined response data 210 based on information included in the query 202 regarding the interactive communication session between the user and the virtual agent device 106.

To do so, the global rule application module 208 may limit portions of the response data 206 to include in the response based on state or federal laws, privacy practices, or ethics standards that are part of the global rule set 142. Alternatively or additionally, the global rule application module 208 may modify the response data 206 to generate refined response data 210 by adding information included in the global rule set 142, or altering the information included in the response data 206 based on the global rule set 142.

A local rule application module 212 receives the refined response data 210, and applies the local rule set 136 to the refined response data 210. The local rule application module 212 further refines the refined response data 210 to generate refined response data 214, based on one or more rules from the local rule set 136. For instance, the local rule application module 212 can generate refined response data 214 based on information included in the query 202 regarding the interactive communication session between the user and the virtual agent device 106.

To do so, the local rule application module 212 may limit portions of the refined response data 210 to include in the response based on the user's account information with the context-specific application 108, preferences that the user has stored with the context-specific application 108, the user's relationships with other users or other applications associated with the context-specific application 108, rules on how the context-specific application 108 handles data in the local fact set 134, and so forth. Alternatively or additionally, the local rule application module 212 may further modify the refined response data 210 to generate the refined response data 214 by adding information included in the local rule set 136, or altering the information included in the refined response data 214 based on the local rule set 136.

The process of generating refined response data 214 may occur over several iterations between the data retrieval module 204, the global rule application module 208, and/or the local rule application module 212. Additionally, the process of generating a refined response may take place in any order between any combination of the data retrieval module 204, the global rule application module 208, and/or the local rule application module 212. The response generation module 102 may compare rules from one or multiple local and/or global rule sets until a “consensus” is reached between the rule sets to arrive at final, refined data for a response. For example, the global rule set 142 and the local rule set 136 may initially present conflicting rules, in which case the response generation module 102 may determine which of the conflicting rules to apply to refine the response data 206. In some scenarios, the response generation module 102 may not select between the global rule set 142 and the local rule set 136 to apply to the response data 206, but instead sends a response to be output to the user to supply an input on which rule set to apply.

When the response data 206 has been refined by the global rule application module 208 and the local rule application module 212 to generate the refined response data 214, the refined response data 214 is output to the natural language processing module 128. The natural language processing module 128 generates natural language response data 216 that contains the refined response data 214, in a format that can be output by the virtual agent device 106. For example, the natural language response data 216 generated by the natural language processing module 128 may be text to be translated into a text-to-speech response, a document to be output to a display, a file or folder location, text and/or an attachment to be included in an email, confirmation of an action executed by the virtual agent service provider system 104, waving a hand, and so forth.

A response output module 218 of the virtual agent service provider system 104 outputs the natural language response data 216 to the virtual agent device 106. The virtual agent device 106 receives the natural language response data 216 via the communication module 126, and can then output the natural language response data 216 with the natural language input/output module 124 in a variety of ways. The natural language input/output module 124 may utilize information included in the natural language response data 216 from the global rule set 142 and/or the local rule set 136 to determine how to output the natural language response data 216 to a user.

Having considered an example implementation of a response generation module, consider now a description of example scenarios that may be carried out as part of an interactive communication session utilizing a virtual agent for the retrieval and analysis of information in greater detail.

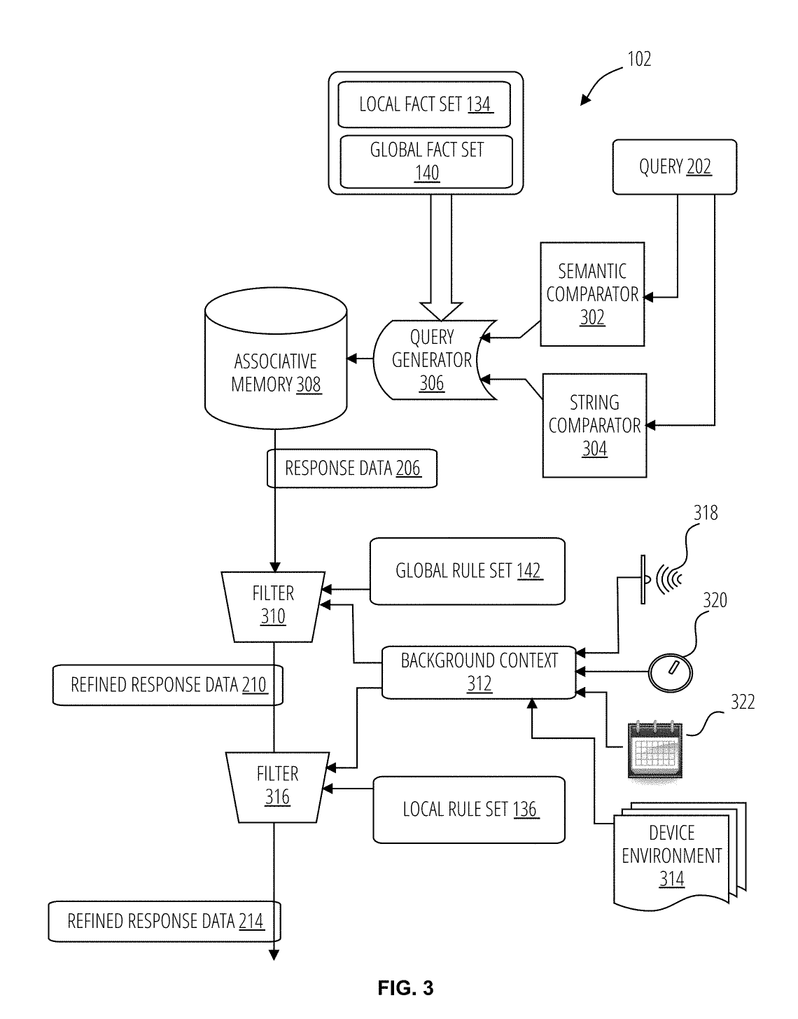

Referring to FIG. 3, in one embodiment the response generation module 102 comprises a semantic comparator 302, string comparator 304, query generator 306, associative memory 308, a first filter 310, and a second filter 316.

The query 202 is processed by the semantic comparator 302 and the string comparator 304 to ascertain features of the query such as literal keywords, literal phrases, and semantically similar constructs to the literal keywords and phrases. The outputs of the semantic comparator 302 and string comparator 304 form a first feature vector input to the query generator 306. The local rule set 136 and global fact set 140 form a second feature vector for the query generator 306, which utilizes these inputs to generate a query against the associative memory 308 to produce the response data 206, in manners known in the art.

The response data 206 from the associative memory 308 is input to the filter 310, which refines the response data 206 into the refined response data 210 based on the global rule set 142. Refinement may involve removing candidate responses from the response data 206 in accordance with restrictions configured in the global rule set 142, and further influenced/restricted by the background context 312.

The background context 312 may be generated from various inputs such as a location sensor 318, a timer 320, a calendar 322, and a device environment 314. The device environment 314 may include a device identifier (e.g., identifying and possibly associating a computing device that is executing or accessing the response logic with a person or organization). The device environment 314 may further include one or more applications executing on the computing device, for example an application that is executing or interfacing with the response logic.

The refined response data 210 is provided to the filter 316, which further refines the response into the refined response data 214 based on one or both of the local rule set 136 and the background context 312.

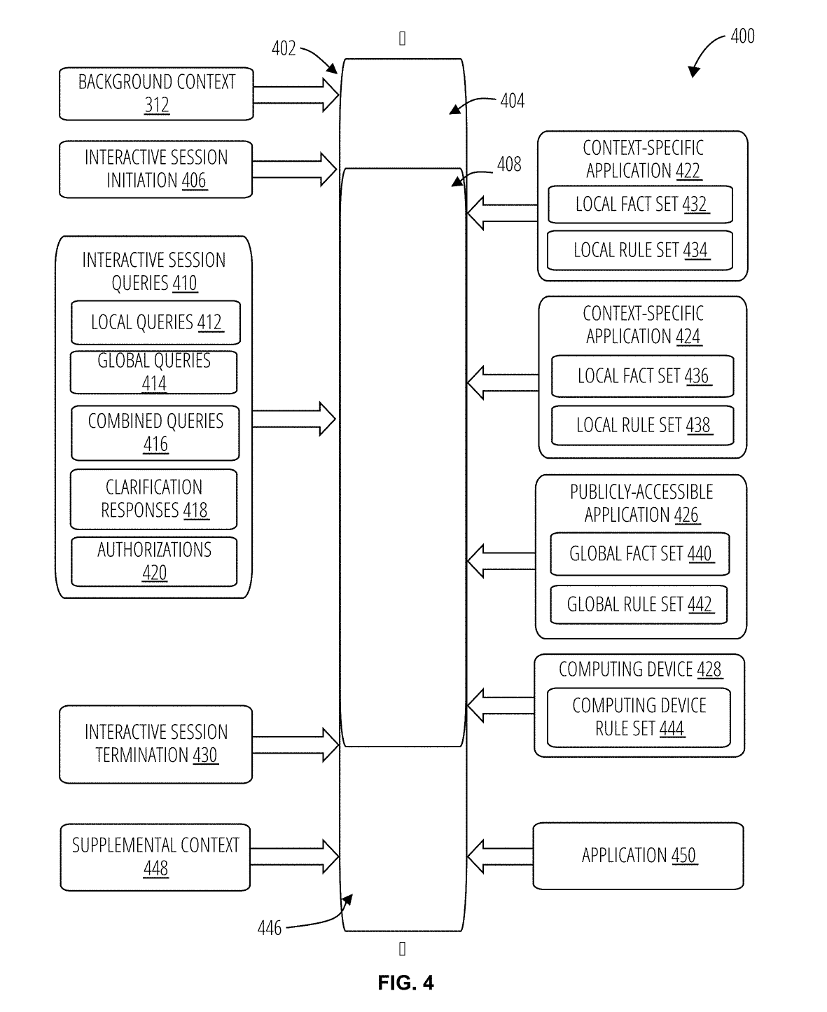

FIG. 4 depicts an example structure 400 of an interactive communication session 402 that may be implemented in different scenarios utilizing a virtual agent for the retrieval and analysis of information. The interactive communication session 402 may be between one or more users and a virtual agent device, such as the virtual agent device 106 of FIG. 1.

The interactive communication session 402 may take place over a period of time, which is represented by the illustration of the interactive communication session 402 from top to bottom, where events take place as time passes from top to bottom in the example structure 400.

An initial period of time 404 may pass before a user directly engages a virtual agent device 106 as part of the interactive communication session 402. During the initial period of time 404, the virtual agent device 106 may gather information that may be used as a background context 312 for the interactive communication session 402. Background context 312 may include determining a number or identity of voices that are speaking around a microphone of the virtual agent device 106, a location of the virtual agent device 106, account information of a user of the virtual agent device 106, and so forth.

The virtual agent device 106 receives an interactive session initiation 406 from a user to begin a particular interactive communication session 408. For example, the interactive session initiation 406 may include receiving a verbal “wake word” from a user via a microphone of the virtual agent device 106, such as the word “computer” in the phrase “Computer, read me the text of my most recent email.” In another example, the interactive session initiation 406 may be a user selecting an icon in a user interface to begin a chat session with a customer support chatbot. In another example, the interactive session initiation 406 may be a user directing her gaze to a defined area located on the physical embodiment of the virtual agent device 106. In another example, the interactive session initiation 406 may be a user pointing a finger at the physical embodiment of the virtual agent device 106. In other examples, the interactive session initiation 406 may be prompted by a non-user trigger such as a preset time or the occurrence of a news event conforming to some predetermine definition of significance. In such an example, it is envisioned that the interactive session may initiate without the user taking any affirmative action. Other examples of interactive session initiations are also contemplated.

When the particular interactive communication session 408 has begun, the user may submit any number of interactive session queries 410 as part of the particular interactive communication session 408. The interactive session queries 410 may include local queries 412, global queries 414, combined queries 416, clarification responses 418, and/or authorizations 420, to name a few examples. Local queries 412 are queries that seek information or a response from context-specific applications, such as context-specific application 422. Global queries 414 are queries that seek information or a response from a public source, such as publicly-accessible application 426. Combined queries 416 are queries that seek information or a response from both a context-specific application 422 and a publicly-accessible application 426. Clarification responses 418 are responses by the user to questions by the virtual agent device 106 to explain one or more aspects of the user's previous input so that the virtual agent device 106 can provide an appropriate response to the user. Authorizations 420 give the virtual agent device 106 permission to perform an action, and may include a password or pass-phrase, a credit card number, an address or phone number, an email address, a gesture input, a biometric security input, and so forth. In response to the interactive session queries 410 during the particular interactive communication session 408, a virtual agent service provider system (e.g., the virtual agent service provider system 104 of FIG. 1) may submit queries to one or more applications or devices to generate responses to the queries. The virtual agent service provider system 104 may access content-specific applications, such as context-specific application 324, which may have functionality similar to that of the context-specific application 108 of FIG. 1. The virtual agent service provider system 104 may access publicly-accessible applications, such as publicly-accessible application 426, which may have functionality similar to that of the publicly-accessible application 110 of FIG. 1. The virtual agent service provider system may also access computing devices, such as computing device 428, which may have a variety of functionality as discussed above and below. When a user wishes to terminate the particular interactive communication session 408, the user may submit an interactive session termination 430. The interactive session termination 430 may be performed in a variety of ways, such as a voice input, closing a chat window, hanging up a telephone, powering off the virtual agent device 106 that is taking part in the particular interactive communication session 408, making a hand gesture, and so forth. In some examples, the virtual agent service provider system 104 may execute actions after the interactive session termination 430, such as in a final period of time 446. During the final period of time 446, supplemental context 448 may be supplied to the virtual agent service provider system 104, such as a new location of the user, a different device that the user is actively using, and so forth. Further, the virtual agent service provider system 104 may interact with an application 450 during the final period of time 446, for example to provide a transcript of the particular interactive communication session 408, monitor for relevant information, execute commands that took place during the particular interactive communication session 408, and so on. The application 450 that is interacted with during the final period of time 446 may be context-specific application 422; the publicly-accessible application 426; an application of the computing device 428; or may be a different application that was not accessed during the particular interactive communication session 408.

With a background for an example structure of an interactive communication session 402, consider the following example that utilizes the example structure below.

In an example use case, a user submits an interactive session initiation 406 to a virtual agent device, such as the Amazon Echo™ device, by saying, “Hey Alexa, start Asset Manager.” In this example, the word “Alexa” is a wake word used as an interactive session initiation 406, and Asset Manager is a context-specific application 422. In response to this command the virtual agent service provider system 104 initiates a particular interactive communication session 408, and opens the context-specific application 422. This command may be considered by the virtual agent service provider system 104 as an utterance to generate one or more local queries 412 to start the context-specific application 326. With the interactive session initiation 406, the virtual agent device 106 begins to generate information on the context of the particular interactive communication session 408.

In this example, the virtual agent service provider system 104 knows that Asset Manager is a context-specific application 422 that supplies information about X-type assets. Therefore, the virtual agent device 106 responds, through a speaker of the virtual agent device 106, “Ok, what would you like to know about X-type assets?”

The user responds, “What assets has James Elwood Borg generated?” The virtual agent service provider system 104 uses this utterance to generate a query, such as by using the natural language processing module 128 and/or the query generation module 130 of FIG. 1. The virtual agent service provider system 104 may consider this utterance as a local query 314 for the context-specific application 422. The virtual agent service provider system 104 thus sends the query to the context-specific application 422, in this case Asset Manager. The context-specific application 422 uses the query to locate data from a local fact set 334 that is part of the context-specific application 422. The context-specific application 422 returns the data for the response to the virtual agent service provider system 104, which generates a response based on the data as discussed above, such as with the response generation module 102 of FIG. 1.

The virtual agent device 106 receives the response, and responds, through the speaker of the virtual agent device 106, “James Elwood Borg is listed as a contributor on X-type assets A and B.”

The user then responds by asking, “Who owns those assets?” Based on the context of the particular interactive communication session 408, the virtual agent service provider system 104 knows that the intent of the pronoun “those” applies to the asset identifiers that the virtual agent device 106 supplied in the previous response. The virtual agent service provider system 104 may also consider this utterance as local queries 412 for the context-specific application 422. Similar to the previous question by the user, the virtual agent service provider system 104 can send a query to the context-specific application 422 for a response to who owns the assets. Based on response data from the local fact set 432 obtained by the virtual agent service provider system 104, the virtual agent device 106 can provide a natural-language output “Asset A is owned by General Electric Corporation and asset B is owned by James Elwood Borg.”

The user then asks, “What is the status of asset B?” In a general context, the word “status” can be quite ambiguous, and difficult for conventional systems to generate an appropriate response. However, the virtual agent system described herein utilizes both the context of the particular interactive communication session 408, along with local rule set 434 of the context-specific application 422 to determine a relevant and disambiguated response to the user's utterance. The virtual agent service provider system 104 may consider this utterance as one of the local queries 412 for the context-specific application 422.

In this example, the virtual agent service provider system 104 generates a query based on the user's utterance, and submits the query to the context-specific application 422. The virtual agent service provider system 104 can submit the query to the context-specific application 422 based on the context of the particular interactive communication session 408, knowing that the previous queries were sent to the context-specific application 422. The query may indicate, for example, the identification of the asset, and an identification that the user wants to know the status of the asset.

The context-specific application 422 utilizes a rule from the local rule set 434, to determine that “status” has a specific meaning in the context of an X-type asset with a particular status. The context-specific application 422 can return the rule from the local rule set 434 as part of the response for the virtual agent service provider system 104 to use in generating a natural language response. Alternatively, the context-specific application 422 may return the data from the local fact set 432 for the status of the asset to the virtual agent service provider system 104 with information on how the rule applies to the data. The virtual agent service provider system 104 generates a response to the query based on the data from the local fact set 432, which has been modified by the rule from the local rule set 434 applied to the data.

The virtual agent device 106 receives the response and outputs, through the speaker, “Asset B is still in effect. A payment of $3,700 is due on Sep. 18, 2017 to continue maintaining the asset. Would you like me to pay this fee?” The question “Would you like me to pay this fee?” is an event trigger that the user did not ask for, but may be supplied as part of the response based on the context of the particular interactive communication session 408 and rules in the local rule set 434.

In one example, the context-specific application 422 may identify that the maintenance fee is due on the asset in response to the query provided by the virtual agent service provider system 104. As part of the response supplied by the context-specific application 422, a rule from the local rule set 434 may instruct the virtual agent service provider system 104 to query other applications to identify information that may be relevant to the particular interactive communication session 408. A rule from the local rule set 434 may instruct the virtual agent service provider system 104 to query the context-specific application 422, in this case an application that manages the user's billing and account information, to determine if the user manages an account for the asset in question.

The context-specific application 422 receives the query and locates data from the local fact set 432 indicating that the patent attorney does manage an account for asset B. The context-specific application 422 utilizes a local rule set 434 associated with the context-specific application 422 to determine the type of account that the user manages for asset B as an escrow account. The context-specific application 422 additionally identifies a rule from the local rule set 434 to prompt a user for payment as part of a response to the user's inquiry if an escrow account is present.

The virtual agent service provider system 104 receives the data indicating that the user manages an account associated with asset B, and the rules instructing a prompt to ask if the user would like to make a payment using the account. The virtual agent service provider system 104 generates the response of “Asset B is still in effect. A fee payment of $3,700 is due on Sep. 18, 2017. Would you like me to pay this fee?” This response utilizes data from two local fact sets (local fact set 432 and local fact set 436), which has been refined according to two local rule sets (local rule set 434 and local rule set 438).

Next, the user says, “Yes, please. Pay that fee on behalf of the James Elwood Borg Trust Account from their escrow account.” Again, the virtual agent service provider system 104 generates a query based on the user's utterance, and the context of the particular interactive communication session 408. The virtual agent service provider system 104 may consider this utterance as one of the combined queries 416 for the context-specific application 422, and the publicly-accessible application 426. First, the virtual agent service provider system 104 sends the query to the context-specific application 422. The context-specific application 422 utilizes the information in the query to identify the James Elwood Borg Trust Account from the local fact set 432. To do so, the context-specific application 422 may utilize a rule from the local rule set 434 to identify that the James Elwood Borg Trust Account is naming an account at a bank rather than a human's proper name in the context of the particular interactive communication session 408.

The context-specific application 422 may also include a rule in the local rule set 434 that a security check must be made before taking any actions on accounts that the user manages using the context-specific application 422. Additionally, the context-specific application 422 may also include a rule in the local rule set 434 to send a confirmation email of any actions taken on accounts that the user manages using the context-specific application 422. The context-specific application 422 provides a response to the query to the virtual agent service provider system 104 that includes the data from the local fact set 432 and the rules from the local rule set 434.

The virtual agent service provider system 104 then translates the response from the context-specific application 422 into a natural language output, and the natural language output is sent to the virtual agent device 106. The virtual agent device 106 responds, “You got it. To confirm, I will pay the fee on asset B of $3,700 on behalf of the James Elwood Borg Trust Account from its escrow account. I will email you a confirmation as well as the points of contact for the James Elwood Borg Trust Account. If this is correct, please say your security confirmation phrase.”

The user then says, “Yes, that is correct. My security confirmation phrase is Walnut Octopus Weaver Fish Trousers.” This utterance by the patent attorney may be considered by the virtual agent service provider system 104 as both one or more clarification responses 418 to pay the fee, and one or more authorizations 420 to pay the fee. In response to receiving this utterance from the user via the virtual agent device 106, the virtual agent service provider system 104 generates several queries. A first query sends the security confirmation phrase to verify correctness of the security confirmation phrase with the context-specific application 422.

When the security confirmation phrase is verified by the context-specific application 422, the virtual agent device 106 accesses the publicly-accessible application 426, for example a government website, to pay the fee. The virtual agent service provider system 104 may access a current version of the fee schedule from a global fact set 440 to verify the amount to pay for the fee. The virtual agent service provider system 104 can navigate the online payment system of the publicly-accessible application 426 using the user's account information from the local fact set 432 of the context-specific application 422 and the global rule set 442 that provides rules to execute payment for the publicly-accessible application 426.

Upon completion of payment of the fee, the global rule set 442 may supply a rule to indicate in a response confirmation of the payment, along with data from the global fact set 440 relating to the payment confirmation. When the virtual agent service provider system 104 receives the rule and data from the publicly-accessible application 426, the virtual agent service provider system 104 refines the response to be output by the virtual agent device 106 to state “Action confirmed. Is there anything else I can help you with?” Additionally, the virtual agent service provider system 104 sends an email containing the payment confirmation from the publicly-accessible application 426 along with the points of contact for the James Elwood Borg Trust Account, e.g., from the local fact set 432 of the context-specific application 422.

Based on the context of the particular interactive communication session 408, the virtual agent service provider system 104 generates a custom email containing these two pieces of information, rather than simply forwarding the payment confirmation email from the publicly-accessible application 426. Thus, the virtual agent service provider system 104 refines the response based on the local fact set 432 and the global local fact set 432 and the local fact set 432 and the global rule set 442 based on the context of the interactive communication session 402. The virtual agent service provider system 104 may interact with an additional, email context-specific application (not pictured) in order to generate the custom email, utilizing local fact sets and local rule sets of the email context-specific application.

The user then responds, “Yes, one last thing. Can you make a note in my smart watch with that asset number?” The virtual agent service provider system 104 may consider this utterance as one of the local queries 412 for the computing device 428. The virtual agent service provider system 104 once again generates a query based on the user's utterance, and the context of the particular interactive communication session 408. For example, the virtual agent service provider system 104 can interpret the context of the particular interactive communication session 408 to select asset B from the two assets that were included in the particular interactive communication session 408 to include in the query, as this was the asset that involved the most recent interaction between the user and the virtual agent service provider system 104.

The virtual agent service provider system 104 sends the query to the computing device 428, in this case the user's smart watch device. In response to receiving the query, the computing device 428 can generate a note including asset B. The computing device 428 may utilize a computing device rule set 444 to supply a confirmation of the completed note back to the virtual agent service provider system 104. The computing device rule set 444 includes rules specific to the computing device 428. The computing device rule set 444 may also include rules for applications of the computing device 428, such as a notes application of the computing device that generates the note for asset B.

The virtual agent service provider system receives a response from the computing device 428 confirming that the note has been generated in accordance with the computing device rule set 444. The virtual agent service provider system supplies a natural language response via the virtual agent device as discussed above, stating “All right, I've made a note in your smart watch for asset B. Is there anything else I can help you with?”

The user responds, “Nope, that's it for now.” This utterance may cause the interactive session termination 430 of the particular interactive communication session 408. Even though the particular interactive communication session 408 has ended, the virtual agent service provider system may take additional, follow-up actions during the final period of time 446. For example, the virtual agent service provider system my receive data regarding supplemental context 448 when the user leaves the room where the virtual agent device is located. Further, the virtual agent service provider system may interact with the application 450 during the final period of time 446, such as by automatically sending a transcript and/or summary of the particular interactive communication session to the user's email account, monitoring for any subsequent emails from the government regarding asset B, and so forth.

The interactive communication session 402 described above represents but one example of how a virtual agent device and virtual agent service provider system can interact with context-specific applications, publicly-accessible applications, and devices to provide relevant responses based on global and local rule sets applied to data depending on a particular interaction context. Additional integrations with the above example system may include annuity maintenance systems, prior art search systems, stock trading account systems, trustee account systems, deal room account systems, interviewing systems, and so forth.

Having considered an example of an interactive communication session between a user and a virtual agent, consider now an example of additional features of a context-specific application in further detail.

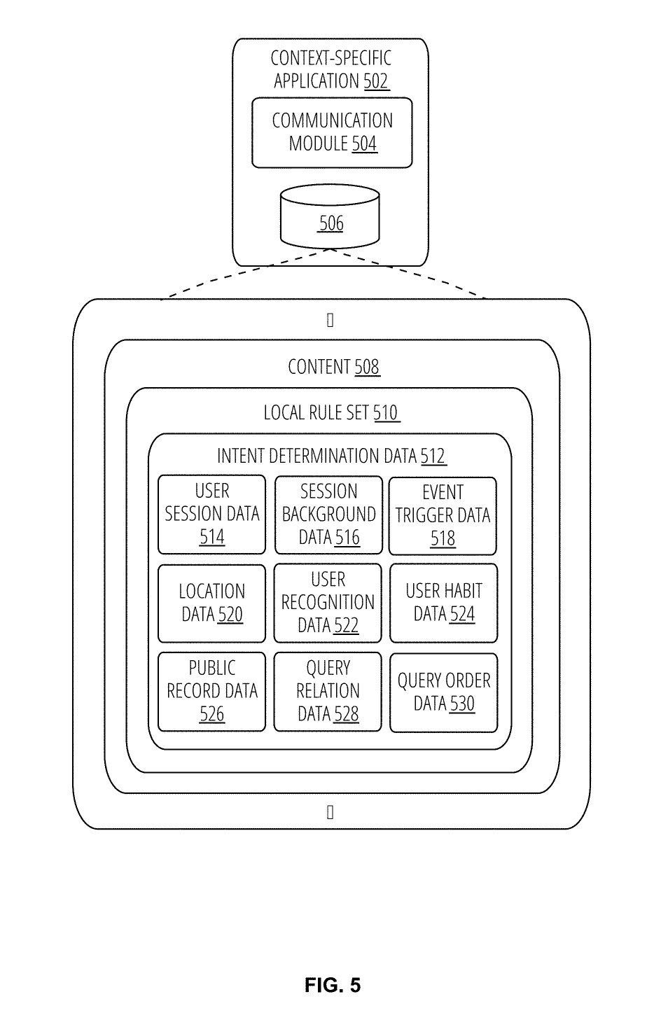

FIG. 5 depicts examples of additional features and functionalities that may be used in an example implementation of using a virtual agent for the retrieval and analysis of information. A context-specific application 502 is shown, which may provide functionality as described with relation to the context-specific application 108 of FIG. 1, and/or the context-specific application 422 or context-specific application 424 of FIG. 4. The context-specific application 502 includes a communication module 504, which is configured to send and receive queries and responses to queries, such as with a virtual agent service provider system 104 via a network 112 as described above.

The context-specific application 502 is also shown as including storage 506, which stores content 508, similar to the storage 120 of FIG. 1. The content 508 within the storage 506 includes a local rule set 510 that includes rules specific to the context-specific application 502. The context-specific application 502 may use data supplied in a query, such as interaction context data, along with rules in the local rule set 510 and intent determination data 512 of the local rule set 510 to generate responses to the query. The intent determination data 512 provides the context-specific application 502 with relationships and information that assist in selecting appropriate rules to apply to a local fact set based on an interaction context.

For example, the intent determination data includes user session data 514. The user session data 514 includes information on prior sessions with a user, which may be tracked when a user logs into their account, by using cookies, and so on. The user session data 514 also includes information on prior sessions with other users, which may include aggregating data on multiple users to track trends, predict outcomes, and so forth.

The intent determination data 512 also includes session background data 516, which can include data received prior to an interactive session initiation 406 such as determining a number of voices that are speaking around a microphone of the virtual agent device 106, a location of the virtual agent device 106, account information of a user of the virtual agent device 106, and so forth. The session background data 516 can also include information about what is happening in an environment around a user and/or a virtual agent device 106, such as applications or documents currently displayed on a screen at the user's location, a song being output by a speaker at the user's location, and so on.

Additionally, the intent determination data 512 includes event trigger data 518. Event triggers are events that are executed without a direct prompt by a user. The event trigger data 518 includes scenarios that may cause an event to execute without a direct prompt by a user, along with how to execute the event without the prompt by the user. For example, a user says as part of an interactive communication session 402, “Give me a list of all General Electric patents that relate to Tesla Motor's battery technology.” Using the event trigger data, the virtual agent can respond with “Ok, would you like me to also include PDF copies of each of the patents?” In this example, the user only asked for a list of patents, but an event trigger set to respond to such requests is queued to ask if the user would also like PDF copies of the patents as well. Event trigger data 518 may be included from other context-specific applications (not pictured) in order to provide an integrated experience between all of a user's applications. For example, the event trigger data 518 may include data from a docket management system, a calendar application, a Dropbox® application, and so forth.

Further, the intent determination data 512 includes location data 520. The location data 520 provides information on a location of one or more users within a room, a location of one or more users in a building, a geographic location of a user, locations of a user's other devices, and so on. For example, a user may command a virtual agent to display a document for review by the user. The virtual agent can use location information of the user and location information of the user's devices to determine that the user is in a conference room away from their desktop. The virtual agent can then display the document on a large display screen in the conference room rather than on the user's desktop without further input by the user.

The intent determination data 512 also includes user recognition data 522. The user recognition data 522 includes passwords, authentication phrases, voice recognition, biometric authentication information, and so on that can be used for one or multiple users of the context-specific application 502.

The intent determination data 512 additionally includes user habit data 524. The user habit data 524 includes data from monitoring how a user uses the context-specific application 502. The user habit data 524 can be used to provide more relevant responses to queries the more the user uses the context-specific application 502. In an example, user habit data 524 for a doctor using a patient management application would likely be different than user habit data for a scheduling assistant using the patient management application. However, both the doctor's habits and the scheduling assistant's habits may be tracked to assist in intent determination for response generation as both users continue using the patient management context-specific application 502.

In addition, the intent determination data 512 includes public record data 526. The public record data 526 includes data that is publicly accessible and specific to the context-specific application 502. For example, the public record data 526 may include upcoming court dates, news stories, application deadlines (e.g., for college admission, marathon entry, job application, and so on), public transportation schedules, concert dates, asset ownership records, and so forth.

The intent determination data 512 further includes query relation data 528. The query relation data 528 includes data on a plurality of example utterances that share a same or similar intent, which may result in a particular query to be generated. This may include interchanging any number of words or phrases in a natural language input to generate the same query. The query relation data 528 may include previous natural language inputs provided by a user, and the context-specific application 502 may aggregate the user's previous natural language inputs to better determine an intent of the user.

Finally, the intent determination data 512 includes query order data 530. The query order data 530 includes different meanings or intent based on an order that queries were received. For example, a user asking a question at the start of an interactive communication session 402 may elicit a broader answer along with a follow-up question by the context-specific application 502 (e.g., the result of an event trigger), than if the same question was asked after a series of questions that narrowed the context of the interactive communication session 402, based on the query order data 530.

Having considered example systems for the implementation of the retrieval and analysis of information using a virtual agent, consider now an example procedure which may be executed by the described systems for the retrieval and analysis of information using a virtual agent in accordance with one or more implementations.

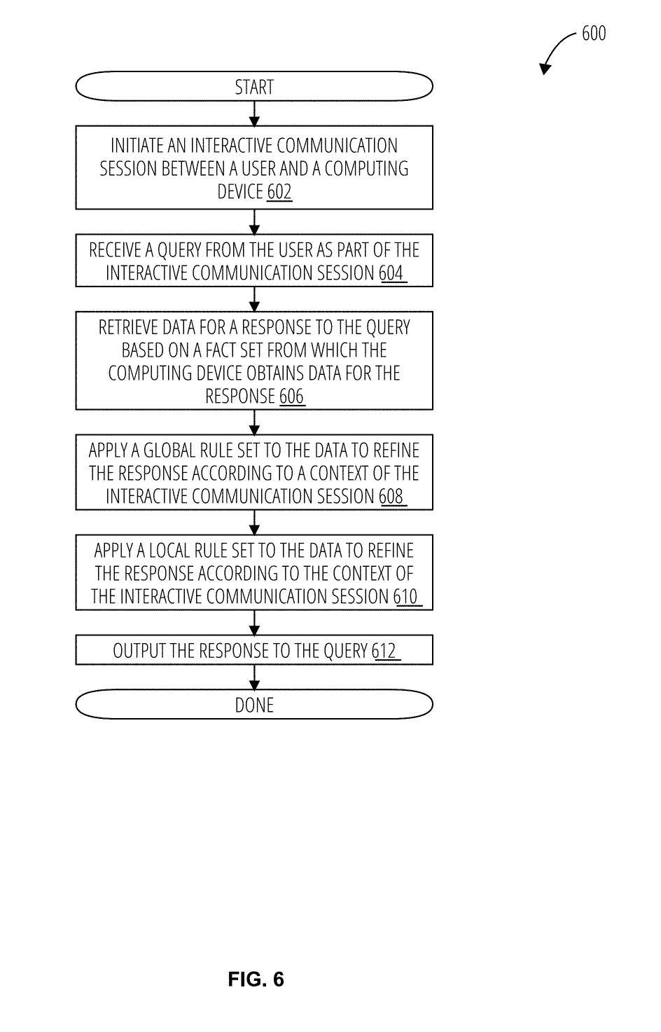

FIG. 6 depicts a procedure 600 in an example implementation in which a virtual agent is used for the retrieval and analysis of information. First, an interactive communication session is initiated between a user and a computing device (block 602). The computing device may be a virtual agent device, which may take the form of a computing device having a hands-free speaker that is controlled by voice commands; a desktop, laptop, or mobile computing device; or a mobile or landline telephone, to name a few examples. The interactive communication session may be initiated by voice activation of a computing device via a “wake word”, by opening a chat box in a user interface of a computing device, by calling a customer service telephone number, and so forth.

A query is received from the user as part of the interactive communication session (block 604). The query may be in the form of a natural language input, and translated from the natural language input to computer-executable instructions. In one example, the user may ask aloud as part of the interactive communication session, “Do I have any unread emails?” This natural language question may be translated into a query by the natural language processing module 128 of the virtual agent service provider system 104 into instructions that are comprehendible by a computer, using techniques described above. Based on information in the query, the virtual agent module 114 may communicate the query to appropriate context-specific applications and/or publicly accessible applications for a response.

Data for a response to the query is retrieved based on a fact set from which the computing device obtains data for the response (block 606). The fact set may be the local fact set 134 containing data specific to the context-specific application 108, and may be secure data that requires an account or authentication for consumption. Alternatively or additionally, the fact set may be the global fact set 140 containing data that, while specific to the publicly-accessible application 110, can be consumed without an account or access restrictions.

A global rule set is applied to the data to refine the response according to a context of the interactive communication session (block 608). The global rule set 142 contains rules that are publicly accessible, and are specific to the publicly-accessible application 110. The context of the interactive communication session may relate to background information, user information, a determined intent of the user, queries by the user and responses by the virtual agent device 106 leading up to the query in question, and so forth. Rules supplied from the global rule set 142 may be based on a determined relevance of the rules in the global rule set 142 to the contextual information supplied in the query.

A local rule set is also applied to the data to refine the response according to the context of the interactive communication session (block 610). The local rule set 136 contains rules that are specific to the fact set that supplied the data for the response, and to the context-specific application 108. Rules supplied from the local rule set 136 may also be based on a determined relevance of the rules in the local rule set to the contextual information supplied in the query.

The response to the query is then output including the data as refined by the global rule set and the local rule set based on the context of the interactive communication session (block 612). Outputting the response may comprise translating the response from computer-executable instructions into a natural language output by the natural language processing module 128, followed by a natural language output from a speaker of the virtual agent device 106. Outputting the response may additionally or alternatively comprise displaying a natural language response in a user interface, executing instructions to perform an action (e.g., send an email, play a video, etc.), implementing an event trigger, and so forth.

Having described the embodiments above, consider now an example system that can be utilized to implement one or more of the above-described embodiments.

FIG. 7 illustrates an example system 700 that includes an example computing device 702 that is representative of one or more computing systems and/or devices that may implement the various techniques described herein. This is illustrated through inclusion of the virtual agent module 114. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

The I/O interfaces 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), a virtual reality device, an augmented reality device, speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing device 702 and/or processing system 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” (cloud 714) via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

Terminology used herein should be accorded its common meaning in the relevant art, unless otherwise indicated expressly or by context:

“Global rule set” refers to rules defined by regulatory organizations (governments, professional associations, agencies, etc.)

“Application” refers to logic that implements specific functionality and which can be invoked independently of other application logic. Examples of applications are word processors, spreadsheets, presentation programs, drawing programs, interviewing programs, web sites, and software-as-a-service applications. The terms “application” should be understood to have its normal meaning the art consistent with the above, for example including what is conventionally called a “software program” but further encompassing web-based purpose-build and independent logic such as interactive web sites with computational or procedural coding.

“Local fact set” refers to data that applies only in a specific environmental context.

“Publicly-accessible application” refers to an application that executes in a public context, which is a context with no implicit environmental context.

“Local rule set” refers to rules specific to a particular environmental context and lower in a precedence hierarchy than global rules.

“Context-specific application” refers to an application that executes in a specific environmental context, said context being implicitly understood to be present if the application is being executed. Context-specific applications are implicitly associated with a specific environmental context and hence with a local rule set. Examples are interviewing applications, purpose-built word processors or authoring tools, human resource applications, and medical or diagnostic applications.

“Global fact set” refers to data that applies regardless of an environmental context.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention. Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A computer-implemented method comprising:
initiating an interactive communication session between a user and a computing device;
receiving a query from the user as part of the interactive communication session; generating a response to the query, the response to the query based on:
a fact set from which the computing device obtains data for the response;
a global rule set that the computing device applies to the data to refine the response according to a context of the interactive communication session, the global rule set being publicly accessible; and
a local rule set that the computing device applies to the data to refine the response according to the context of the interactive communication session, the local rule set comprising rules specific to the fact set; and
outputting the response to the query.
